(19) United States
(12) Patent Application Publication
(10) Pub. No.: US 2004/0028775 A1
(43) Pub. Date: Feb. 12, 2004

(54) Process for providing a starch product, treating milled or grinded crop kernels with an aqueous solution with an acidiic protease activity

(76) Inventors: Hans Sejr Olsen, Holte (DK); Bjarne Ronfeldt Nielsen, Virum (DK)

Correspondence Address: NOVOZYMES NORTH AMERICA, INC., 500 FIFTH AVENUE, SUITE 1600, NEW YORK, NY, 10110, US

(21) Appl. No.: 10/312,238

(22) PCT Filed: Jun. 20, 2001
(86) PCT No.: PCT/DK01/00430

(30) Foreign Application Priority Data
Jun. 28, 2000 (DK) PA200000999
Jun. 30, 2000 (US) 60215581

(51) Int. Cl. A23K 1/00

(52) U.S. Cl. 426/52

(57) ABSTRACT

The present invention relates to an improved process of treating crop kernels, comprising soaking the kernels in water for 1-12 hours, wet milling the soaked kernels and treating the kernels with one or more enzymes including an acidic protease.

### FIELD OF THE INVENTION

The present invention relates to an improved process of treating crop kernels to provide a starch product of high quality suitable for conversion of starch into mono- di-, oligosaccharides, ethanol, sweeteners etc. Further, the invention also relates to an enzyme composition comprising one or more enzyme activities suitable for the process of the invention and to the use of the composition of the invention.

### BACKGROUND OF THE INVENTION

Before starch—being an important constituent in the kernels of most crops, such as corn, wheat, rice, sorghum bean, barley or fruit hulls—can be used for conversion of starch into saccharides, such as dextrose, fructose; alcohols, such as ethanol; and sweeteners, the starch must be made available and treated in an manner to provide a high purity starch. If starch contains more than 0.5% impurities, including the proteins, it is not suitable as starting material for starch conversion processes. To provide such pure and high quality starch product starting out from the kernels of crops, the kernels are often milled, as will be described further below.

The Composition of Corn Kernels

Corn kernels, such as the yellow dent corn kernel, have an outer covering referred to as the “Pericarp” that protects the germ in the kernels. It resists water and water vapour and is undesirable to insects and microorganisms.

The only area of the kernels not covered by the “Pericarp” is the “Tip Cap”, which is the attachment point of the kernel to the cob.

The “Germ” is the only living part of the corn kernel. It contains the essential genetic information, enzymes, vitamins, and minerals for the kernel to grow into a corn plant. About 25 percent of the germ is corn oil. The endosperm covered surrounded by the germ comprises about 82 percent of the kernel dry weight and is the source of energy (starch) and protein for the germinating seed. There are two types of endosperm, soft and hard. In the hard endosperm, starch is packed tightly together. In the soft endosperm, the starch is loose.

Wet Milling

Wet milling is often used for separating corn kernels into its four basic components: starch, germ, fiber and protein.

Typically wet milling processes comprise four basic steps. First the kernels are steeped for 30 to 48 hours to begin breaking the starch and protein bonds. The next step in the process involves a coarse grind to separate the germ from the rest of the kernel. The remaining slurry consisting of fiber, starch and protein is finely grounded and screened to separate the fiber from the starch and protein. The starch is separated from the remaining slurry in hydrocyclones. The starch then can be converted to syrup or alcohol.

Dry Milling

In dry milling processes crop kernels, in particular corn kernels, are grinded in substantially dry state, without presoaking the kernels to separate the kernels into its major constituents: starch, germ, fiber and protein.

Today enzymes are not commonly for the first step in the wet or dry milling of crop kernels. However, the use of enzymes has been suggested for the steeping step of wet milling processes.

The commercial enzyme product Steepzyme® (available from Novozymes A/S) have been shown suitable for the first step in wet milling processes, i.e., the steeping step where corn kernels are soaked in water.

There is a need for improvement of processes for providing starch suitable for conversion into mono-, di-oligosaccharides, ethanol, sweeteners etc.

### BRIEF DESCRIPTION OF THE DRAWINGS

FIG. 1 shows a corn wet milling process.

FIG. 2 shows a dry milling process including starch and protein recovery process. In the case of corn the feed product is similar to corn gluten and the protein is similar to corn gluten meal.

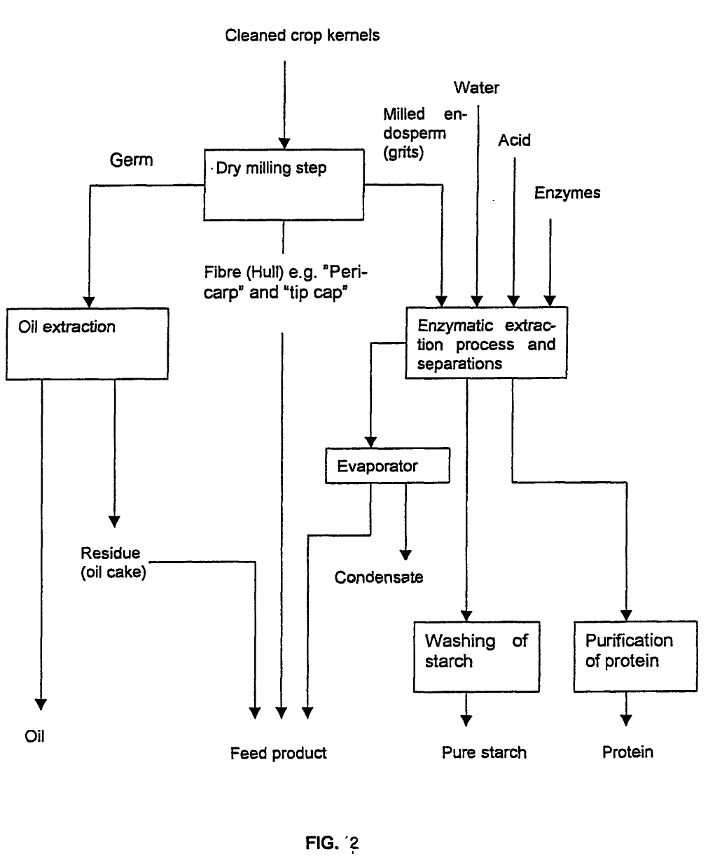

### DETAILED DESCRIPTION OF THE INVENTION

Accordingly, the object of the invention is to provide an improved process of treating crop kernels to provide starch of high quality and/or an improved process.

When using the term “kernels” it is intended to include kernels from corn (maize), rice, barley, sorghum bean, or fruit hulls, or wheat.

In the context of the present invention, the term “enriched” is intended to indicate that the enzyme activity in question of the enzyme preparation has been increased, e.g., with an enrichment factor of at least 1.1, conveniently due to addition of a recombinant mono-component enzyme.

The Milling Process

The kernels are milled in order to open up the structure and to allow further processing and to separated the kernels into the four main constituents: starch, germ, fiber and protein.

Two processes are used: wet or dry milling. In dry milling processes the whole kernels are milled and used in the remaining part of the process. Wet milling gives a very good separation of germ and meal (starch granules and protein) and is often applied at locations where there is a parallel production of syrups.

Dry Milling

Dry milling processes are well known in the art. The term “dry milling” is in the context of the invention meant to include all such processes where the kernels are grinded in dry state.

Dry milling may for instance be carried out as follows: Dry kernels are first cleaned to remove chaff and other external vegetable matter. The hulls of the cleaned dry kernels are intentionally broken to facilitate subsequent milling, and passed through an impact-degerminating mill to loosen up the kernels germ. The discharge from the degerminating mill, comprising germ, fibre (hull) and endosperm (which is the raw material for the starch recovery process), is sifted into fractions according to particle size. The sifted fractions are subjected to suction using air aspirators, which separates the hull fiber. The dehulled discharge from the air aspirators, comprising germ and endosperm, is passed over vibrating gravity tables to separate the germ from the endosperm. The germ is collected from the gravity tables and, if desired, sent to oil expelling station.

Wet Milling

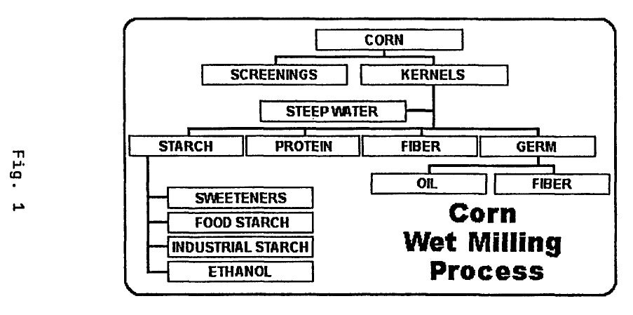

Degradation of the kernels of corn (see also FIG. 1) and other crop kernels into starch suitable for conversion of starch into mono-, di-, oligo saccharides, ethanol, sweeteners etc. consists essentially of four steps:

1. Steeping and germ separation,

2. Fiber washing and drying,

3. Starch gluten separation,

4. Starch washing.

1. Steeping and Germ Separation

Corn kernels are softened by soaking in water for between 30 and 48 hours at a temperature of about 50° C. During steeping, the kernels absorb water, increasing their moisture levels from 15 percent to 45 percent and more than doubling in size. The addition of 0.1 percent sulfur dioxide (SO₂) and/or NaHSO₃ to the water prevents excessive bacteria growth in the warm environment. As the corn swells and softens, the mild acidity of the steepwater begins to loosen the gluten bonds within the corn and release the starch. After the corn kernels are steeped they are cracked open to release the germ. The germ contains the valuable corn oil. The germ is separated from the heavier density mixture of starch, hulls and fiber essentially by “floating” the germ segment free of the other substances under closely controlled conditions. This method serves to eliminate any adverse effect of traces of corn oil in later processing steps.

2. Fiber Washing and Drying

To get maximum starch recovery, while keeping any fiber in the final product to an absolute minimum, it is necessary to wash the free starch from the fiber during processing. The fiber is collected, slurried and screened to reclaim any residual starch or protein.

3. Starch Gluten Separation

The starch-gluten suspension from the fiber-washing step, called mill starch, is separated into starch and gluten. Gluten has a low density compared to starch. By passing mill starch through a centrifuge, the gluten is readily spun out.

4. Starch Washing.

The starch slurry from the starch separation step contains some insoluble protein and much of solubles. They have to be removed before a top quality starch (high purity starch) can be made. The starch, with just one or two percent protein remaining, is diluted, washed 8 to 14 times, re-diluted and washed again in hydroclones to remove the last trace of protein and produce high quality starch, typically more than 99.5 percent pure.

Process of the Invention

The inventors of the present invention have surprisingly found that the quality of the starch final product may be improved by treating crop kernels in a process, comprising the steps of:

i) soaking the kernels in water for 1-12 hours;

ii) grinding the soaked kernels obtained in step i);

iii) treating the grinded kernels from step ii) in the presence of an effective amount of an acidic protease activity.

In an embodiment of the invention the kernels are soaked in water for 2-10 hours, preferably about 3-5 hours at a temperature in the range between 40 and 60° C., preferably around 50° C.

0.01-1%, preferably 0.05-0.3, especially 0.1% SO₂ and/or NaHSO₃ may be preferred during soaking.

The inventors also found that an improved process is provided by treating crop kernels in a process, comprising the steps of:

i) dry milling the kernels,

ii) treating the milled kernels in the presence of an effective amount an acidic protease in an aqueous solution.

In an embodiment of the invention the dry milled kernels from step i) is grinded in a wet state (water is added) until an average particle diameter of below 450 micro meters (i.e., 50% of the particles have a diameter below 450 micro meters), preferably below 200 micro meter, especially below 100 micro meter, has been obtained. The fine flour obtained is then treated with enzyme in step ii).

The processes of the invention result in comparison to traditional processes in a higher starch quality, in that the final starch product is more pure and/or a higher yield is obtained and/or less process time is used. Another advantage may be that the amount of chemicals, such as SO₂ and NaHSO₃, which-need to be used, may be reduced or even fully removed.

Acidic Proteases

Suitable acidic proteases include fungal and bacterial proteases, i.e., proteases characterized by the ability to hydrolyze proteins under acidic conditions below pH 7.

Suitable acid fungal proteases include fungal proteases derived from Aspergillus, Mucor, Rhizopus, Candida, Coriolus, Endothia, Enthomophtra, Irpex, Penicillium, Sclerotium and Torulopsis. Especially contemplated are proteases derived from Aspergillus niger (see, e.g., Koaze et al., (1964), Agr. Biol. Chem. Japan, 28, 216), Aspergillus saitoi (see, e.g., Yoshida, (1954) J. Agr. Chem. Soc. Japan, 28, 66), Aspergillus awamori (Hayashida et al., (1977) Agric. Biol. Chem., 42(5), 927-933, Aspergillus aculeatus (WO 95/02044), or Aspergillus oryzae; and acidic proteases from Mucor pusillus or Mucor miehei.

In an embodiment the acidic protease is a protease clomplex from A. oryzae sold under the tradename Flavourzyme® (from Novozymes A/S) or an aspartic protease from Rhizomucor miehei or Spezyme® FAN or GC 106 from Genencor Int.

In a preferred embodiment the process of the invention is carried out in the presence of the acidic Protease I derived from A. aculeatus CBS 101.43 in an effective amount.

The kernels are subjected to the 0.1% (w/w) of the kernels Steepzyme® enriched to provide a total HUT/100 g DS kernels from 4,000-20,000 HUT/100 g DS kernels acidic protease, preferably 5,000-10,000 HUT/100 g, especially from 6,000-16,500 HUT/100 g DS kernels.

The acidic protease may be added in an amount of 1-10,000 HUT/100 g DS kernels, preferably 300-8,000 HUT/100 g DS kernels, especially 3,000-6,000 HUT/100 g DS kernels.

In a preferred embodiment the acidic protease is an aspartic protease, such as an aspartic protease derived from a strain of Aspergillus, in particular A. aculeatus, especially A. aculeatus CBD 101.43.

Preferred acidic proteases are aspartic proteases, which retain activity in the presence of an inhibitor selected from the group consisting of pepstatin, Pefabloc, PMSF, or EDTA. Protease I derived from A. aculeatus CBS 101.43 is a such acidic protease.

Xylanase

In a preferred embodiment of the invention an effective amount of a xylanase activity is also present or added during treatment of the milled kernels.

The xylanase activity may be derived from any suitable organism, including fungal and bacterial organisms, such as Aspergillus, Disporotrichum, Penicillium, Neurospora, Fusarium and Trichoderma.

Examples of suitable xylanases include xylanases derived from H. insolens (WO 92/17573); Aspergillus tubigensis (WO 92/01793); A. niger (Shei et al., 1985, Biotech. and Bioeng. Vol. XXVII, pp. 533-538, and Fournier et al., 1985, Biotech. Bioeng. Vol. XXVII, pp. 539-546; WO 91/19782 and EP 463 706); A. aculeatus (WO 94/21785).

In a specific embodiment the xylanase is Xylanase I, II, or III disclosed in WO 94/21785.

Contemplated commercially available xylanase include Shearzyme®, Biofeed wheat® (from Novozymes A/S) and Spezyme® CP (from Genencor Int.).

The xylanase may be added in an amount of 1-100 FXU, preferably 5-90 FXU, especially 10-80 FXU per 100 g DS kernels.

Cellulases

In another preferred embodiment an effective amount of a cellulase activity is also present or added during treatment of the milled kernels.

The cellulase may be of microbial origin, such as derivable from a strain of a filamentous fungus (e.g., Aspergillus, Trichoderma, Humicola, Fusarium). Specific examples of cellulases include the endo-glucanase (endo-glucanase I) obtainable from H. insolens and further defined by the amino acid sequence of FIG. 14 in WO 91/17244 and the 43 kD H. insolens endoglucanase described in WO 91/17243.

Commercially available cellulase which may be used include Celluclast®, Celluzyme® (available from Novozymes A/S), Spezyme® CP (available from Genencor Int.) and Rohament® 7069 W (available from Röhm, Germany).

The cellulase may be added in an amount of 1-1,000 NCU, preferably 170-900 NCU, especially 200-800 NCU per 100 g DS kernels.

Arabinofuranosidase

In an even further embodiment of the process of the invention an effective amount of an arabinofurasidase activity is also present or added during treatment of the milled kernels.

Examples of contemplated arabinofuranosidases include A. niger alpha-L-arabinofuranosidase A and B disclosed in WO 97/42301; the Aspergillus sp. arabinofuranosidase disclosed in EP 871,745; the Aspergillus niger K1 alpha-L-arabinofuranosidase disclosed in DD 143925.

Other Enzyme Activities

According to the invention an effective amount of one or more of the following activities may also be present or added during treatment of the kernels: endoglucanase, beta-glucanase, pentosanase, pectinase, arabinanase, xyloglucanase activity.

It is believed that after the division of the kernels into finer particles the enzyme(s) can act more directly and thus more efficiently on cell wall and protein matrix of the kernels. Thereby the starch is washed out more easily in the subsequent steps.

Composition of the Invention

The invention also relates to an enzyme composition. The composition may comprise a single enzyme activity or a combination of enzyme activities.

An object of the invention is to provide a composition suitable for treating kernels of crops according to the invention comprising an acidic protease and one or more of the following enzyme activities: endoglucanase, beta-glucanase, xylanase, cellulase, pentosanase, pectinase, and/or arabinofurasidase or mixtures thereof.

In an embodiment the composition comprise xylanase and acidic protease activity. The composition may further comprise arabinofurasidase and/or cellulase activity.

In another embodiment the composition of the invention comprising a cellulase and acidic protease activity. The composition may further comprise arabinofurasidase and/or xylanase activities.

In a further embodiment of the invention the composition comprises an arabinofurosidase and acidic protease activity.

The composition may further comprise cellulase and/or xylanase activity.

In a preferred embodiment the composition of the invention is Steepzyme® (available from Novozymes A/S) enriched with a cellulase and/or xylanase and/or arabinofuranosidase and/or an acidic protease. The composition may comprise more than 3740 HUT/g enzyme, more than 45 FXU/g enzyme, more than 1694 NCU/g enzyme.

Preparation of Steepzyme®

Steepzyme® is a liquid plant cell wall degrading enzyme preparation prepared from Aspergillus aculeatus CBS 101.43, publicly available from the Centraalbureau voor Schimmelcultures, Delft, NL. Steepzyme® comprises a number of enzyme activities, including endoglucanase activity (about 585 EGA/g); fungal beta-glucanase activity (about 187 FBG/g); Fungal xylanase activity (45 FXU/g); acidic protease activity (3,740 HUT/g); cellulase 1,694/g); pentosanase activity (77 PTU/g); pectinase activity (18,700 PSU/g). The production of the Steepzyme® enzyme mixture is described in U.S. Pat. No. 4,478,939.

The enzyme composition of the invention may in an embodiment comprise one or more of the above mentioned mono-components activities constituting Steepzyme® enriched with a dosage of more than 3740 FXU/g acidic protease activity (3740 HUT/g is the HUT/g activity of Steepzyme®); preferably enriched with between 1 and 20,000 HUT/g, more preferred 500 and 16,000 HUT/g, even more preferred 6,000 to 16,000 HUT/g acidic protease activity.

Use of a Composition of the Invention

A composition of the invention may be used for treating kernels, such as to treat soaked milled and grinded kernels, or dry milled kernels. In a specific embodiment the composition may be used in a process according to the invention.

Materials & Methods

Enzymes:

Steepzyme®: multi activity enzyme complex derived from A. aculeatus CBS 101.43 (is available from Novozymes A/S on request), Shearzyme®: A. aculeatus CBS 101.43 xylanase II disclosed in WO 94/21785 (is available from Novozymes A/S)

Flavourzyme®: multi proteolytic activity enzyme complex derived from A. oryzae (is available from Novozmes A/S)

Protease I: Acidic protease from Aspergillus aculeatus, CBS 101.43 disclosed in WO 95/02044

Methods

Determination of Protease HUT Activity:

The HUT activity was determined according to the AF92/2 method published by Novozymes A/S, Denmark. 1 HUT is the amount of enzyme which, at 40° C. and pH 4.7 over 30 minutes forms a hydrolysate from digesting denatured hemoglobin equivalent in absorbancy at 275 nm to a solution of 1.10 μg/ml tyrosine in 0.006 N HCl which absorbancy is 0.0084. The denatured hemoglobin substrate is digested by the enzyme in a 0.5 M acetate buffer at the given conditions. Undigested hemoglobin is precipitated with trichloroacetic acid and the absorbance at 275 nm is measured of the hydrolysate in the supernatant.

Determination of Xylanase Activity (FXU)

The endo-xylanase activity is determined by an assay, in which the xylanase sample is incubated with a remazol-xylan substrate (4-O-methyl-D-glucurono-D-xylan dyed with Remazol Brilliant Blue R, Fluka), pH 6.0. The incubation is performed at 50° C. for 30 min. The background of non-degraded dyed substrate is precipitated by ethanol. The remaining blue colour in the supernatant is determined spectrophotometrically at 585 nm and is proportional to the endoxylanase activity.

The endoxylanase activity of the sample is determined relatively to an enzyme standard.

The assay is further described in the publication AF 293.6/1-GB, available upon request from Novozymes A/S, Denmark.

Determination of Endo-Glucanase Units (ECU)

The ECU (endocellulose unit) is determined relatively to an enzyme standard.

Endocellulase decomposes carboxylmethylcellulose, CMC. The resulting reduction in viscosity is determined by a CMC-vibration Viscosimeter (e.g. MIVI 3000 available from Sofraser, France). The prepared substrate solution contain 35 g/l CMC (Blanose Aqualon) in 0.1 M phosphate buffer at pH 7.5. The enzyme sample to be analyzed is determined is dissolved in the same buffer. 0.15 ml standard enzyme solution or the unknown enzyme sample are placed in 10 ml test tubes. 5 ml CMC-substrate solution, preheated to 40° C., is added. The joint solution is mixed thoroughly, incubated for 30 minutes and placed in the viscometer. The method is further described in AF302/1-GB available from Novozymes A/S upon request.

Determination of Endo-Glucanase Activity (EGU)

The fermentation broths are analyzed by vibration viscosimetry on CMC at pH 6.0. More specifically, a substrate solution containing 34.0 g/l CMC (Blanose Aqualon) in 0.1 M phosphate buffer, pH 6.0 is prepared. The enzyme sample to be analyzed is dissolved in the same buffer. 14 ml substrate solution and 0.5 ml enzyme solution are mixed and transferred to a vibration viscosimeter (e.g. MIVI 3000 available from Sofraser, France) thermostated at 40° C. Endoglucanase unit (EGU) is determined as the ratio between the viscosity of the sample and the viscosity of a standard enzyme solution.

Cellulytic Activity

The cellulytic activity is determined with carboxymethyl cellulose (CMC) as substrate. One Novo Cellulase Unit (NCU) is defined as the amount of enzyme which, under standard conditions (i.e. at pH 4.80; 0.1 M acetate buffer; 10 g/l Hercules CMC type 7 LFD as substrate; an incubation temp. of 40.0° C.; an incubation time of 20 min; and an enzyme concentration of approximately 0.041 NCU/ml) forms an amount of reducing carbohydrates equivalent to 1 micro mol glucose per minute. A folder AF 187.2/1 describing this analytical method in more detail is available upon request to Novozymes A/S, Denmark, which folder is hereby included by reference.

Arabinofuranosidase Assay

The synthetic substrate p-nitrophenyl alpha-L-arabinofuranoside (SIGMA) is used as substate. Following cleavage of the enzyme, the p-nitrophenyl molecule is liberated and the development in yellow colour can be measured by visible spectrometty at 405 nm. Stock solution: 1 mg/ml p-nitrophenyl alpha-L-arabinofuranoside in DMSO. Substrate solution: 0.2 mg/ml p-nitrophenyl alpha-L-arabinofuranoside diluted in 50 mM Sodium acetate, pH 4.5. Procedure: 100 microlitre enzyme and 100 microlitre is mixed in a 96-well plate and the development of yellow colour due to the enzymatic reaction is measured from 0 to 15 minutes at 405 nm. The slope of the time dependent OD405 curve is directly proportional to the amount of alpha-arabinofuranosidase.

### EXAMPLE 1

Commercial Yellow corn meal (YCM) was milled fine in a pin mill. 125 kg of this fine milled YCM was mixed into 375 kg of city water. The slurry was heated to 40° C. and then pumped through a Fryma mill type MZ-130 with a rotary crusher using a setting of the clearance between the cone and the shell so that the main part of the wetmilled product could pass a screen of 106 μm. The flow through the Fryma mill was 600 litres per hour at a backpressure of 3 Bar. During the wetmilling the temperature was raised to 50° C.

pH was adjusted to 4.5 using 25% phosphoric acid. 0.25% Steepzyme and 0.05% Flavourzyme based on the dry matter content of YCM was added and the reaction slurry was wetmilled once more using a flow through the Fryma mill of 600 litres per hour at a backpressure of 0.3 Bar. The temperature was maintained at 50° C. by cooling.

After 18 hours of reaction time a final wetmilling was performed. The material was separated on a decanter centrifuge (Westfalia Separator) in a rough starch fraction (heavy phase) and a light phase consisting of gluten and fibre material.

In pilot plant focus was on the wet milling step, the hydrolysis reaction and on the separation of starch and gluten using a decanter centrifuge. Judged from the samples taken out an almost complete separation of the reaction mixture was obtained already after 5 hours reaction time. This indicated that a considerable reduction of the reaction time from 24 hours to a few hours is possible.

1. A process of treating crop kernels, comprising the steps of:
i) soaking the kernels in water for 1-12 hours;
ii) grinding the soaked kernels obtained in step i);
iii) treating the grinded kernels from step ii) in the presence of an effective amount of an acidic protease activity.

2. A process of treating crop kernels, comprising the steps of:
i) dry milling the kernels,
ii) treating the milled kernels in the presence of an effective amount of an acidic protease in an aqueous solution.

3. The process of claim 2, wherein the dry milled kernels in step i) are grinded in wet state until the kernels have an average particles diameter of below 450 micro meters, preferably below 200 micro meters, especially below 100 micro meters and then subjected to step ii).

4. The process of claims 1-3, wherein an effective amount of a xylanase activity is also present or added during treatment of the kernels.

5. The process of claims 1-4, wherein an effective amount of a cellulase activity is also present or added during treatment of the kernels.

6. The process of claims 1-5, wherein an effective amount of an arabinofurasidase activity is also present or added during treatment of the kernels.

7. The process of claim 1-6, wherein an effective amount of one or more of the following activities is present or added during treatment of the milled kernels: endoglucanase, beta-glucanase, pentosanase, pectinase, arabinanase, and/or xyloglucanase.

8. The process of claims 2-7, wherein the xylanase activity is added in an amount of 1-100 FXU, preferably 5-90 FXU, especially 10 to 80 FXU per 100 g DS kernels.

9. The process of claim 2-8, wherein the cellulase activity is added in an amount of 1-1,000 NCU, preferably 170-900 NCU, especially 200 to 800 NCU per 100 g DS kernels.

10. A process of claims 1-9, wherein the kernels are soaked in water for 2-10 hours, preferably about 3 hours.

11. A process of claims 1-10, wherein the soaking carried out at a temperature between 40 and 60° C., preferably around 50° C.

12. The process of claims 1-11, wherein the soaking is performed in the presence of between 0.01-1%, preferably 0.050.3%, especially 0.1% SO₂ and/or NaHSO₃.

13. The process of claims 1-12, wherein the crop kernels are from corn (maize), rice, barley, sorghum bean, or fruit hulls, or wheat.

14. The process of claims 1-13, wherein the xylanase, and/or cellulase, arabinofurasidase and/or acidic protease is derived from the genus Aspergillus, preferably A. aculeatus, especially A. aculeatus CBS 101.43.

15. The process of claims 1-14, wherein the enzyme activities is derived from Steepzyme® enriched with one or more of the following activities: xylanase, cellulase, arabinosidase, endoglucanase, beta-glucanase, pentosanase, pectinase and/or acidic protease activity.

16. The process of claims 1-15, wherein the acidic protease is protease I derived from A. aculeatus CBS 101.43.

17. The process of claims 1-16, wherein the kernels are subjected to the Steepzyme® enzyme activities enriched to provide a total HUT/100 g DS kernels from 4,000-20,000 HUT/100 g DS kernels acidic protease, preferably 5,000-10,000 HUT/100 g DS kernels, especially from 6,000-16,500 HUT/100 g DS kernels.

18. The process of claims 1-17, wherein the acidic protease is an aspartic protease, such as an aspartic protease derived from a strain of Aspergillus, in particular A. aculeatus, especially A. aculeatus CBS 101.43.

19. The process of claims 1-18, wherein the aspartic protease retains activity in the presence of an inhibitor selected from the group consisting of pepstatin, Pefabloc, PMSF, or EDTA.

20. The process of claim 1-19, wherein the protease is Protease I derived from A. aculeatus CBS 101.43.

21. A composition comprising an acidic protease and one or more of the following enzyme activities: endoglucanase, betaglucanase, xylanase, cellulase, pentosanase, pectinase, arabinofurasidase, arabinanase, and/or xyloglucanase, or mixtures thereof.

22. The composition of claim 21 comprising a xylanase and acidic protease activities.

23. The composition of claim 22, wherein the composition further comprises arabinofurasidase and/or cellulase activities.

24. The composition of claim 21 comprising a cellulase and acidic protease activities.

25. The composition of claim 24, wherein the composition further comprises arabinofurasidase and/or xylanase activities.

26. The composition of claim 21 comprising arabinofurosidase and acidic protease activities.

27. The composition of claim 26, wherein the composition further comprises cellulase and/or xylanase activities.

28. The composition of claim 21, wherein the composition is Steepzyme® enriched with a cellulase and/or a xylanase and/or an arabinofuranosidase and/or an acidic protease.

29. The composition of claim 21-28, comprising more than 3740 HUT/g.

30. The composition of claim 21-29, comprising more than 45 FXU/g.

31. The composition of claim 21-30, comprising more than 1694 NCU/g.

32. Use of a composition of claims 21-31 for treating kernels.

33. Use of claim 31, wherein the kernels are corn or sorghum kernels.
